(19) United States
(12) Patent Application Publication
(10) Pub. No.: US 2022/0124386 A1
(43) Pub. Date: Apr. 21, 2022

(54) CROWDSOURCING PLATFORM FOR ON-DEMAND MEDIA CONTENT CREATION AND SHARING

(71) Applicant: M35creations LLC, Virginia Beach, VA (US)

(72) Inventor: Michael Joseph Ernest, Virginia Beach, VA (US)

(73) Assignee: M35creations LLC, Virginia Beach, VA (US)

(21) Appl. No.: 17/075,475

(22) Filed: Oct. 20, 2020

(51) Int. Cl. H04N 21/2381; H04N 21/238; H04N 21/2387; H04N 21/239; G06F 16/901; G06F 16/9035

(52) U.S. Cl. CPC H04N 21/2381; H04N 21/23805; G06F 16/9035; H04N 21/2393; G06F 16/9017; H04N 21/2387

(57) ABSTRACT

This disclosure describes techniques for servicing on-demand requests by a consumer for a hyper-specific media content in a network environment. The hyper-specific media content may include specified audio, video, other media, or multi-media combination content that relates to hyper-specific criteria. The hyper-specific criteria cover a specifically requested subject and/or object at a specific location, for a specific time, and for a specific future context or event sufficient for a third-party to author media content to capture that context or event. In an example embodiment, the hyper-specific criteria may be used as an authoring qualification to identify specific content creator devices that may capture the particular or future events.

### BACKGROUND

Traditionally, consumers have been forced to consume media content in a relatively structured manner. For example, before the advent of cable television, a consumer had relatively few choices in television programming. The consumer wishing to view a particular program had to determine on which station, and at which time the program would be aired.

Over the past few years, content options for consumers have grown dramatically due to the large number a client software applications that have been introduced in the market. There is an ever-increasing variety of content available to consumers via cable networks, satellite distribution, over-the-air broadcasts, the Internet, etc., including without limitation digital and analog video, audio, and multimedia content. Moreover, a variety of devices, such as wireless phones, handheld devices (including PDA, game consoles, etc.) provide more flexibility in the consumption of such content. Similarly, on-demand services and personal video recorders (“PVR”) have increased the flexibility for consuming such content. As a result, there is a trend toward consumers viewing and/or listening to entertainment content when and where they desire.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a diagram of an example cellular network environment in which the described technological solutions may be implemented.

FIG. 2 is a diagram of an example network server environment in accordance with the described technologies.

FIG. 3 is a block diagram of a look-up table (LUT) that may be used to select content creator devices that can capture a hyper-specific media content.

FIG. 4 is a flow diagram of an example methodological implementation for selecting at least one content creator device based upon authoring qualifications in a consumer request.

FIG. 5 is a flow diagram of an example methodological implementation for selecting at least one content creator device based upon a comparison between geolocation of at least one device and a specific location of the hyper-specific media content.

FIG. 6 is a flow diagram of an example methodological implementation for charging of fees from a consumer device upon based upon a waiting time period.

### DETAILED DESCRIPTION

This disclosure describes techniques for servicing on-demand requests by a consumer for a hyper-specific media content in a network environment. The hyper-specific media content may include specified audio, video, other media, or multi-media combination content that relates to hyper-specific criteria. The hyper-specific criteria cover a specifically requested subject and/or object at a specific location, for a specific time, and for a specific future context or event sufficient for a third-party to author media content to capture that context or event. While there may be publicly available videos of Stonehenge, even ones that capture last year's alignment of the sun at the vernal equinox, there is no guarantee that there would be one for this year. Consumers are presently limited to accessing multi-media content that was created or authored and scheduled by third-parties rather than as specified by the consumers. Accordingly, hyper-specific criteria support requests for hyper-specific media content that is unlikely to be generated let alone purposely available online. With the hyper-specific criteria in the media request, the consumer may now order exactly the content to be created or authored, to the point of being able to capture expected particular or future events, on-demand. Further, the consumer may now specify authoring criteria (or authoring qualifications) to identify specific content creator devices that may capture the particular or future events.

In an example network environment, a content crowdsourcing application (app) in a server may receive a consumer request with associated one or more authoring qualifications. The authoring qualifications may include references to identify content creator devices that may capture a hyper-specific media content referred to by hyper-specific criteria in the consumer request. For example, the authoring qualifications may include hyper-specific criteria, preferred client profiles, requested user ratings, good credit history, a combination of the hyper-specific criteria and client profiles/user ratings, and the like. In this example, the content crowdsourcing app utilizes these authoring qualifications to identify at least one content creator device that may capture the requested hyper-specific media content.

In one example, user-entered hyper-specific criteria in the consumer request may be used as a default authoring qualification. The default authoring qualification may indicate that other user-entered references in the consumer request may also be used to identify the content creator devices. In this regard, the user-entered hyper-specific criteria are not only used to identify the hyper-specific media content but are also used to identify the content creator devices that can capture the identified hyper-specific media content.

When the authoring qualification is based on the hyper-specific criteria in the consumer request, the content crowdsourcing app may compare the hyper-specific criteria in the consumer request with stored hyper-specific criteria in a database. The stored hyper-specific criteria in the database may include the hyper-specific criteria that are associated with previous transmissions of the hyper-specific media contents by the content creator devices. The stored hyper-specific criteria in the database may be further associated with other historical data such as device identifiers of the content creator devices that transmitted the hyper-specific media contents, user ratings, client profiles, and other data that relate to the previous transmissions by the content creator devices. By finding the stored hyper-specific criteria that match the hyper-specific criteria in the consumer request, the content crowdsourcing app may apply or use the associated historical data in the matching stored hyper-specific criteria with the hyper-specific criteria in the consumer request.

For example, the matching stored hyper-specific criteria in the database are associated with previously transmitted hyper-specific media content “A.” The matching stored hyper-specific criteria in the database are also associated with content creator devices “X,” “Y,” and “Z” that captured the hyper-specific media content “A.” In this example, the content crowdsourcing app may identify the content creator devices “X,” “Y,” and “Z” as potential content creator device candidates that can capture the requested hyper-specific media content, which is highly likely to be the same as the hyper-specific media content “A” of the matching stored hyper-specific criteria in the database. In other words, the hyper-specific media content that is referred to by the matching hyper-specific criteria is the same as the requested hyper-specific media content.

Given a situation where no matching hyper-specific criteria are found in the database, the content crowdsourcing app may create a new entry for the hyper-specific criteria and store the newly created hyper-specific criteria in the database. In this regard, the content crowdsourcing app may use other authoring qualifications to identify the potential content creator devices that can capture the requested hyper-specific media content. For example, the content crowdsourcing app may use the proximity of distances by the content creator devices from a specific location in the hyper-specific criteria in the consumer request, preferred user ratings in the consumer request, client profile, good credit history, or other authoring qualification.

As described herein, the consumer device and/or the content creator device is an electronic communication device, including but not limited to, cellular phone, a smartphone, a session initiation protocol (SIP) phone, a laptop, a personal digital assistant (PDA), a satellite radio, a global positioning system (GPS), a multimedia device, a video device, a camera, a game console, a tablet, a smart device, a wearable device, or any other similar functioning device. Each one of the consumer devices or the content creator devices may also be variously referred to as a station, a mobile station, a subscriber station or unit, a wireless unit, a mobile device, a wireless device, an access terminal, a handset, a user agent, a mobile client, or some other suitable terminology.

In one example, the content crowdsourcing app may use the authoring qualifications to filter proposed bids from responding content creator devices. For example, the content crowdsourcing app sends the consumer request to the content creator devices that were identified using the authoring qualifications as described above. In this example, one or more of these content creator devices may respond with proposed bids to capture the hyper-specific media content referred to by the hyper-specific criteria in the consumer request. The proposed bids may include an amount of service fees, a number of allowed retransmissions, cancellation policy, and other conditions for capturing the media content. The content crowdsourcing app may receive these proposed bids and utilize again the authoring qualifications to make sure that the proposed bids comply, for example, with the hyper-specific criteria in the consumer request. Thereafter, the content crowdsourcing app sends the filtered proposed bids to the consumer device. Accordingly, the consumer device may not only able to request the hyper-specific media content but the consumer device may also expect to receive high-quality services from the selected content creator devices (i.e., crowd sourcing).

The hyper-specific criteria in the consumer request may include a specific subject, location, and a time condition. In one example, the time condition may include a time window that is based upon a rate of change of details of interest of the specific subject to be viewed by the consumer. The time window may include a range or time period that overlaps with the rate of change of the specific subject or object that the consumer desires to view. As described herein, the rate of change may include a length of time between an occurrence of the details of interest and the time that the details of interest are expected to end. The time of occurrence includes the desired timing of the details of interest while the ending indicates the range of desired time to view the event.

For example, the consumer desires to view a dropping of the ball at New Year's Eve in Times Square, New York City on the last day of this year. The occurrence of the details of interest is exactly at midnight of the last day of this year and the range of the desired time to view the event may include a few seconds after the occurrence. In this regard, the consumer may enter a time window of at least one minute that will overlap with the rate of change of the dropping of the ball at New Year's Eve in Times Square, New York City on the last day of this year. In another example, the consumer desires to view in real-time a Superbowl halftime show that includes a length of fifteen minutes on a particular day in a subsequent year. In this other example, the occurrence of the details of interest is at the end of the first half of the football game while the desired time to view the event may include at least 15 minutes from the time of occurrence. The rate of change of the football halftime show in this case is fifteen minutes. In this regard, the time window may include a time duration that at least overlaps with the fifteen-minutes time duration of the football halftime show. In an example embodiment, the range of the time window may at least overlap with the rate of change of the details of interest to be viewed by the consumer.

In some examples, the server may use a waiting period as a reference for collecting service fees. The waiting period may include a time duration within the time window where the consumer can back out or reject the transmissions of the hyper-specific media content without incurring financial obligations or paying only a reduced service fee. When a waiting period time duration elapses, the content crowdsourcing app may initiate charging of service fees from the consumer device. In some cases, the waiting period is a user-configurable parameter where the consumer may enter in the consumer request the time duration for the waiting period. In other cases, the server may configure the time window based, for example, upon a policy or terms of engagement that is stored in a policy database. For example, the terms of engagement include a waiting period of ten seconds for a certain classification of hyper-specific media content (e.g., dropping of the ball at New York New Year's Eve). In another example, the preconfigured waiting period include one hour for viewing of a three-day concert, and so on. In these examples, a detection of an initial delivery timestamp of the hyper-specific media content in the consumer device may trigger a timer for the time duration of the waiting period and the time window. Upon the lapse of the waiting period and within the time window, if the user has not rejected the transmissions or otherwise canceled the agreement, then the server may charge the consumer device with service fees. Before the lapse of the waiting period, the server may not charge service fees from the consumer device.

The implementation and operations described above are ascribed to the use of the server; however, alternative implementations may execute certain operations in conjunction with or wholly within a different element or component of the system(s). Further, the techniques described herein may be implemented in a number of contexts, and several example implementations and context are provided with reference to the following figures. The term “techniques,” as used herein, may refer to system(s), method(s), computer-readable instruction(s), module(s)m algorithms, hardware logic, and/or operation(s) as permitted by the context described above and throughout the document.

Example Network Environment

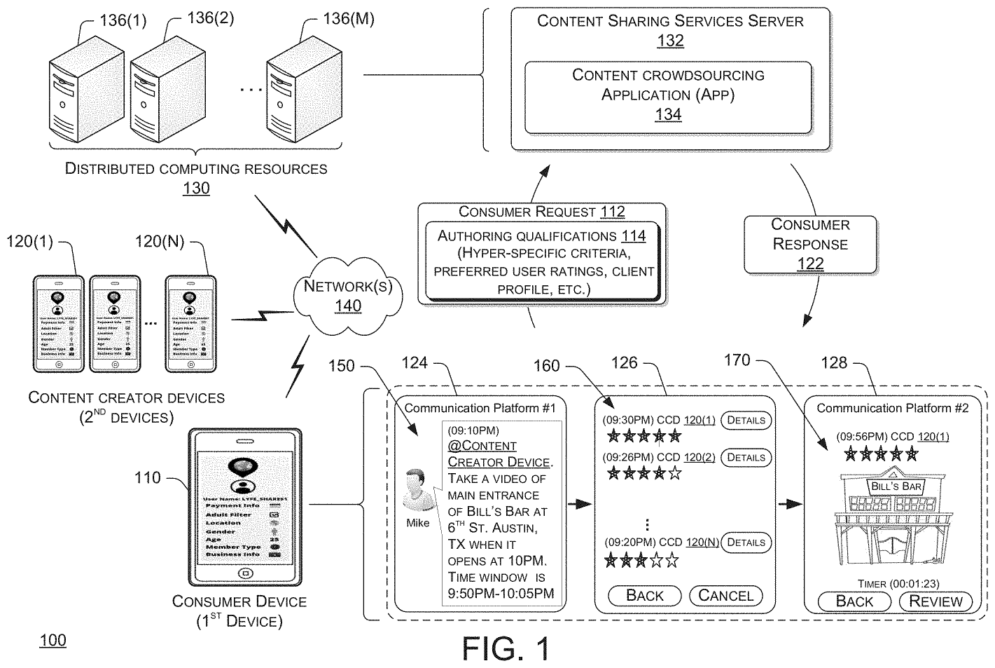

FIG. 1 illustrates a schematic view of a cellular network environment 100 that facilitates a delivery of a hyper-specific media content from a content creator device to a requesting consumer device. In some examples, where consumers desire specific content, the consumers may associate or include hyper-specific criteria in a consumer request to define at least the specific subject, location, and time condition of the hyper-specific media content to be transmitted by the content creator device. In this regard, the consumers may be able to view on-demand the hyper-specific media content without relying on the probability that the hyper-specific media content is handily available through regular Internet searches. Further, the consumers may use the hyper-specific criteria as authoring criteria (or authoring qualifications) to identify specific content creator devices that may capture the hyper-specific media content. In this regard, the hyper-specific criteria in the consumer request are not only used to identify the hyper-specific media content but they are also utilized to identify the content creator device that can capture the identified hyper-specific media content.

The computing environment 100 includes a consumer device 110 that may communicate with a plurality of content creator devices 120(1)-120(N) and distributed computing resources 130 via one or more networks 140. The distributed computing resources 130 may include one or more servers such as a content sharing services server 132. The content sharing services server 132 may further include a content crowdsourcing app 134 that can receive a consumer request 112 including authoring qualifications 114 from the consumer device 110, and in doing so execute an algorithm that facilitates sending of a consumer response 122 back to the consumer device 110. The authoring qualifications 114 may include references for selecting the content creator devices 120 that can transmit a hyper-specific media content. In one example, the hyper-specific criteria in the consumer request may be used as default authoring qualifications 114. Other authoring qualifications 114 that may be combined with the hyper-specific criteria include preferred client profiles, preferred user ratings, credit history, cancellation policy, etc. In response to receiving of the consumer request 112, the consumer response 122 can include back and forth communications with the consumer device 110 including livestreaming of the requested hyper-specific media content. The content crowdsourcing app 134 may include hardware, software, or a combination thereof, that processes the consumer request 112 and sends the consumer response 122 based upon the hyper-specific criteria in the authoring qualifications 114.

The content sharing services server 132 may operate the distributed computing resources 130 that include one or more computing device(s) 136(1)-136(M). The distributed computing resources 130 may operate in a cluster or other configuration to share resources, balance load, increase performance, provide fail-over support or redundancy, or for other purposes. The one or more computing device(s) 136(1)-136(M) may include one or more interfaces to enable communications with other networked devices via one or more network(s) 140. The one or more network(s) 140 may include public networks such as the Internet, private networks such as an institutional and/or personal intranet, or some combination of private and public networks. The one or more network(s) 140 can also include any type of wired and/or wireless network, including but not limited to local area network (LANs), wide area networks (WANs), satellite networks, cable networks, Wi-Fi networks, Wi-Max networks, mobile communications networks (e.g., 3G, 4G, and so forth), or any combination thereof.

The consumer device 110 may include any sort of electronic devices, such as a cellular phone, a gaming device, a personal computer (PC), a laptop computer, etc. The consumer device 110 may have a subscriber identity module (SIM), such as an eSIM, to identify the consumer device 110 to a telecommunication service provider network and/or the content crowdsourcing app 134.

As shown in FIG. 1, the consumer device 110 may display different information on its user interface. For example, input hyper-specific criteria 150 is shown at a first time instant 124. The input hyper-specific criteria 150 may indicate a user-entered specific subject, location, and a time condition. In one example, the input hyper-specific criteria 150 may be associated and used as a default reference for the authoring qualifications 114. In response to the received hyper-specific criteria 150, the content crowdsourcing app 134 sends a selection 160 of content creator devices 120 that may capture the hyper-specific media content referred to by the input hyper-specific criteria 150. The content crowdsourcing app 134, for example, utilizes the authoring qualifications 114 to identify the content creator devices 120 in the selection 160. Thereafter, upon a selection by the consumer device 110 of the content creator device in the selection 160, the content crowdsourcing app 134 may facilitate livestreaming of a hyper-specific media content 170 as shown at a third time instant 128.

In the illustrated example, the consumer device 110 may submit the consumer request 112 to the content sharing services server 132 via a first communication platform (communication platform #1) such as an audio-telecommunications service, an email service, short message service (SMS) platform, multimedia messaging (MMS) platform, a rich communication service (RCS) platform, or a social media messaging platform. However, the consumer response 122 may be delivered via a second communication platform (communication platform #2) as may be selected or preferred by a user of the consumer device 110. For example, a more interactive platform or a communication platform with a higher channel bandwidth may be selected by the user to view the livestream hyper-specific media content 170 at a high or higher quality.

The authoring qualifications 114 may include the input hyper-specific criteria 150, preferred user ratings, and other references that can be used by the content crowdsourcing app 134 to identify the desired content creator devices 120. When the authoring qualification is based on the hyper-specific criteria such as the input hyper-specific criteria 150, the content crowdsourcing app 134 may compare the input hyper-specific criteria 150 with stored hyper-specific criteria in a database (not shown). The stored hyper-specific criteria in the database may be associated with historical data such as previous transmissions of the hyper-specific media contents by the content creator devices 120. By finding the stored hyper-specific criteria that match the input hyper-specific criteria 150 in the consumer request, the content crowdsourcing app 134 may apply or use the associated historical data in the matching stored hyper-specific criteria with the input hyper-specific criteria 150 in the consumer request.

For example, the input hyper-specific criteria 150 specify a request for a video recording of the main entrance of Bill's Bar at Austin, Tex. when it opens at 10:00 PM. In this example, the content crowdsourcing app 134 parses the authoring qualifications 114 (i.e., consumer request 112) and extracts the components of the associated input hyper-specific criteria 150. For example, the extracted components include “Bill's Bar” as the specific object, “6^{th} Street, Austin, Tex.” as the specific location, and “10:00 PM opening” as the intended specific time. Based upon this extracted information, the content crowdsourcing app 134 may search a list of stored hyper-specific criteria in the database to find the hyper-specific criteria that may match the extracted components. Given a situation where matching stored hyper-specific criteria are found, then the content crowdsourcing app 134 may identify the content creator devices 120 that transmitted the hyper-specific media contents that correspond or associated with the matching stored hyper-specific criteria. Upon obtaining device identifications of the content creator devices 120 that transmitted the associated hyper-specific media contents, the content crowdsourcing app 134 may select these identified content creator devices 120 as potential content creator devices that can capture the requested hyper-specific media content. The requested hyper-specific media content is highly likely to be the same as the hyper-specific media content that is associated with the matching stored hyper-specific criteria in the database.

Upon identification of the potential content creator devices 120 from the matching stored hyper-specific criteria in the database, the content crowdsourcing app 134 may further filter the potential content creator devices 120 based upon preferred client profiles, user ratings, etc. in the authoring qualifications 114. In example embodiments, the content crowdsourcing app 134 utilizes this filtering operation to help ensure that the consumer request 112 will only be communicated to the desired content creator devices 120 as specified in the authoring qualifications 114.

In one example, after sending the consumer request 112 to the filtered content creator devices 120, the content crowdsourcing app 134 may receive proposed bids from responding content creator devices 120. The proposed bids may include livestreaming services for the requested hyper-specific media content. In an embodiment, the content crowdsourcing app 134 may further perform filtering of the received proposed bids to make sure that the proposed bids satisfy at least the components of the hyper-specific criteria in the consumer request 112. After this filtering process, the consumer device 110 receives the filtered proposed bids from the content sharing services server 132.

The consumer device 110 may then select at least one bid, and the consumer device 110 sends this information to the particular content creator device 120 that is associated with the selected/accepted bid. Thereafter, the content crowdsourcing app 134 facilitates the displaying of the livestream hyper-specific media content 170 at the third time instant 128 as shown. The livestream hyper-specific media content 170 may include, for example, the real-time video recording of the requested hyper-specific media content.

In some examples, the consumer request 112 includes a time window as the time condition to define the desired time period for viewing of the hyper-specific media content. The time window may include a range or time period that overlaps with the rate of change of the specific subject or object that the consumer desires to view. For example, the consumer is interested in viewing the main entrance of “Bill's Bar, 6^{th} Street, Austin, Tex.” when Bill's Bar opens between 10:00 PM to 2:00 AM. In this example, the rate of change includes an occurrence point at 10:00 PM and an ending point at 2:00 AM or time duration of 4 hours. In this regard, the content crowdsourcing app 134 may configure a time window of at least 4 hours in order to overlap with the rate of change of the details of interest, which includes the opening of Bill's bar between 10:00 PM to 2:00 AM.

Example Network Server Environment

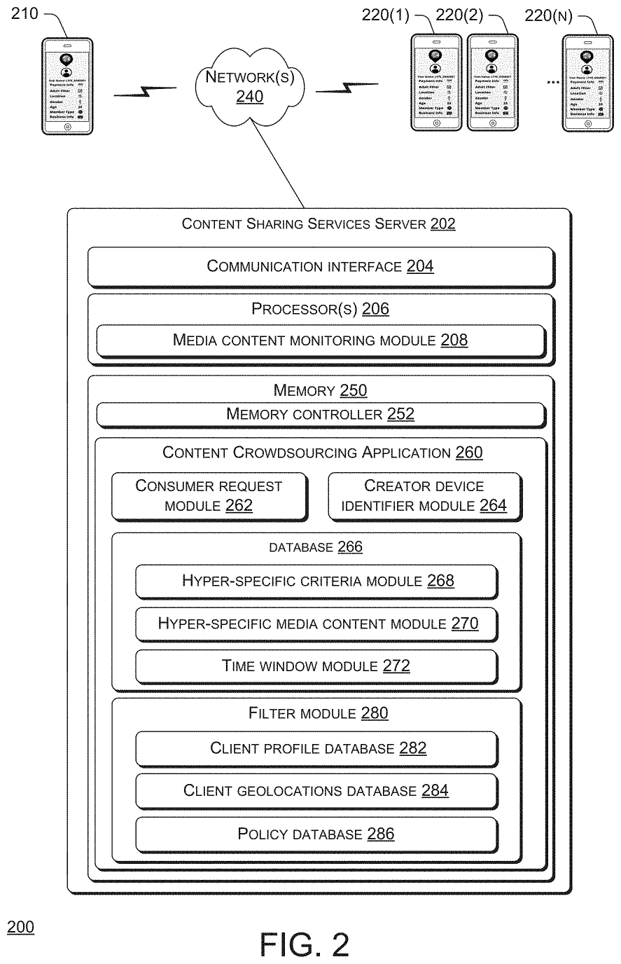

FIG. 2 is a diagram of an example network server environment 200 in accordance with the technologies described herein. The network server environment 200 includes a server such as a content sharing services server 202 that services an on-demand request by a consumer device 210 to view a hyper-specific media content. The content sharing services server 202 facilitates livestreaming of the hyper-specific media content from a transmitting content creator device 220 to the consumer device 210 via networks 240. The one or more content sharing services servers 132 shown in FIG. 1 are examples of the content sharing services server 202 in an extended operating environment, in particular, a cellular network environment 100.

The content sharing services server 202 includes hardware, software, or a combination thereof, that processes a consumer request including the authoring qualifications and sends a consumer response in return (e.g., consumer request 112/consumer response 122 in FIG. 1). The content sharing services server 202 includes a communications interface 204 that facilitates communication with devices, servers, financial services or institutions, social networking platforms, etc. located outside of the content sharing services server 202, and provides networking capabilities for the content sharing services server 202. For example, the content sharing services server 202, by way of the communications interface 204, may exchange data with other electronic devices such as the consumer devices 110, content creator devices 220, other laptops, computers, servers, etc. via the one or more networks 240. Communication between the content sharing services server 202 and other electronic devices may utilize any sort of communication protocol known in the art for sending and receiving data and/or voice communications.

The content sharing services server 202 includes a processor 206 having electronic circuitry that executes instruction code segments by performing basic arithmetic, logical, control, memory, and input/output (I/O) operations specified by the instruction code. The processor 206 can be a product that is commercially available through companies such as Intel® or AMD®, or it can be one that is customized to work with and control a particular system. The processor 206 may include a media content monitoring module 208 configured to monitor details of transactions for each one of the hyper-specific media contents as described herein. In some examples, the details include the number of downloads, retransmissions, purchases, uploads, and the like, by subscribers or third party viewers in the social networking platforms (not shown). Further, the processor 206 may be coupled to other hardware components used to carry out device operations. The other hardware components may include one or more user interface hardware components not shown individually—such as a keyboard, a mouse, a display, a microphone, a camera, and/or the like—that support user interaction with the content sharing services server 202.

The content sharing services server 202 also includes memory 250 that stores data, executable instructions, modules, components, data structures, etc. The memory 250 may be implemented using computer-readable media. Computer-readable media includes, at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc-Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by, modulated data signals, such as a carrier wave. In contrast, communication media may embody computer-readable instructions, data structures, program modules, or other data in a modulated data signal, such as a carrier wave, or other transmission mechanisms.

A memory controller 252 is stored in the memory 250 of the content sharing services server 202. The memory controller 252 may include hardware, software, or a combination thereof, that enables the memory 250 to interact with the communication interface 204, processor 206, and other components of the content sharing services server 202. For example, the memory controller 252 receives the consumer request from the communication interface 204 and sends the received consumer request to a content crowdsourcing app 260 for further processing. In another example, the memory controller 252 may retrieve data from memory 250 where the data will be processed in the processor 206. Still, in another example, the memory controller 252 in communication with the processor 206 and the communication interface 204 may facilitate the sending of the consumer request to the content creator devices 220, and so on. The content crowdsourcing app 260 is similar to the content crowdsourcing app 134 as described above in FIG. 1.

The memory 250 also stores the content crowdsourcing app 260 that, when executed, extracts the hyper-specific criteria in the authoring qualifications, compares the hyper-specific criteria with stored hyper-specific criteria that are associated with previously transmitted hyper-specific media contents, and identifies the content creator devices that are associated with matching stored hyper-specific criteria in the database. In an embodiment, the content crowdsourcing app 260 may treat the identified content creator devices that are associated with the matching stored hyper-specific criteria in the database as potential content creator devices that can capture the requested hyper-specific media content referred to by the hyper-specific criteria in the consumer request.

Further, the content crowdsourcing app 260 may filter/screen the potential content creator devices based upon other authoring qualifications in the consumer request. For example, the other authoring qualifications include preferred client profiles, user ratings, and the like. With the filtered content creator devices, the content crowdsourcing app 260 sends the consumer request to these filtered content creator devices, and the receiving content creator devices may respond with proposed bids. In one example, the content crowdsourcing app 260 compares components of the proposed bids with the extracted hyper-specific criteria to make sure that they comply with the desired hyper-specific criteria. Thereafter, the content crowdsourcing app 260 facilitates delivery or livestreaming of the hyper-specific media content to the consumer device 210. The content crowdsourcing app 260 may be a single block of executable instructions or it may be made up of several components, as shown. The components included in at least one implementation are described below. However, it is noted that in other implementations, more or fewer components may be configured and that one or more operations attributed to a particular component in the following description may be implemented in one or more other components.

As shown, the content crowdsourcing app 260 includes a consumer request module 262, a creator device identifier module 264, and a database 266 including a hyper-specific criteria module 268, associated hyper-specific media content module 270, and a time window module 272. Also shown in FIG. 2 and stored in the memory 250, are a filter module 280, a client profile database 282, a client geolocation database 284, and a policy database 286. Although shown as part of the content crowdsourcing app 260, the client profile database 282, client geolocation database 284, and policy database 286 may be stored in other memory (not shown), in another content sharing services server, or in remote locations. Further, each component of the content crowdsourcing app 260 can be realized in hardware, software, or a combination thereof. For example, the creator device identifier module 264 is a software module designed to perform specific processes as described herein.

The consumer request module 262 may be configured to receive and process a plurality of consumer requests (e.g., consumer request 112 in FIG. 1) from consumer devices. The consumer request includes, for example, the authoring qualifications (e.g., authoring qualifications 114 in FIG. 1) that include the hyper-specific criteria, preferred client profile, user rating, or a combination thereof, as references to identify the content creator device that can capture the desired hyper-specific media content referred to by the hyper-specific criteria in the consumer request. In one example, the consumer request module 262 may extract the components of the hyper-specific criteria to be compared with the components of the stored hyper-specific criteria in the database.

For example, the received consumer request includes audio data, text data, image data, a pin drop, etc. that may represent the hyper-specific criteria for the requested hyper-specific media content. In this example, the consumer request module 262 may parse and extract the audio data and text data of the request via natural language processing (NLP) and natural language understanding (NLU) algorithms to determine a literal and intended meaning of the audio/text data in the consumer request. Further, the consumer request module 262 may extract the image data of the consumer request by extracting feature representations of the image data and determining similarities with a dataset of stored images within the database 266. The consumer request module 262 may then use a probabilistic machine learning algorithm (not shown) in order to identify the specific object in the consumer request. The consumer request module 262 may also parse the pin drop by utilizing the database 266 to search for the associated specific subject and location, and so on. After extracting the components, the consumer request module 262 may send the extracted components (i.e., specific subject, location, and like) to the creator device identifier module 264 for further processing.

The creator device identifier module 264 may be configured to select the content creator device 220 that can capture the hyper-specific media content for a particular event. The creator device identifier module 264 may utilize the authoring qualifications to perform the selection. In one example, the creator device identifier module 264 may use the information in the hyper-specific criteria module 268, hyper-specific media content module 270, client profile database 282, client geolocations database 284, and the policy database 286 for the selecting of the content creator devices 220.

In an example embodiment, the creator device identifier module 264 may utilize the extracted components from the hyper-specific criteria to identify the potential content creator devices that can capture the hyper-specific media content for a particular event. For example, the creator device identifier module 264 may compare the extracted components of the hyper-specific criteria with the stored components in the stored hyper-specific criteria in the hyper-specific criteria module 270. The stored hyper-specific criteria may be associated with historical data such as the hyper-specific media contents that were previously transmitted by the content creator devices. In this example, upon finding of the stored hyper-specific criteria that match the hyper-specific criteria in the consumer request, the creator device identifier module 264 may apply or use the associated historical data in the matching stored hyper-specific criteria with the hyper-specific criteria in the consumer request.

For example, the matching stored hyper-specific criteria in the database are associated with previous transmissions by the content creator devices 220(1)-220(10) of a particular concert in Bill's Bar, 6^{th} Street, Austin, Tex. during weekends (hyper-specific media content). In this example, the creator device identifier module 264 may select the content creator devices 220(1)-220(10) as potential content creator devices that can capture the hyper-specific criteria in the consumer request. In this example still, the hyper-specific media content that is associated with the matching stored hyper-specific criteria is highly likely to be the same as the requested hyper-specific media content in the consumer request.

Given a situation where no matching hyper-specific criteria are found in the hyper-specific criteria module 270, the creator device identifier module 264 may create an entry of hyper-specific criteria and store the newly created hyper-specific criteria in the hyper-specific criteria module 270. In this situation, the creator device identifier module 264 may use other references in the authoring qualifications to identify the potential content creator devices 220 that can capture the requested hyper-specific media content. For example, the creator device identifier module 264 may use the proximity of distances by the content creator devices 220 from the extracted specific location in the hyper-specific criteria in the consumer request, utilize the preferred user ratings in the consumer request, client profile, good credit history, etc. In this example, the creator device identifier module 264 may utilize at least the client profile database 282 and the client geolocations database 284 to identify the potential content creator devices.

In other cases, where the matching hyper-specific criteria are found in the hyper-specific criteria module 270, the creator device identifier module 264 may also combine with the hyper-specific criteria the other references in the authoring qualifications. For example, upon identification by the creator device identifier module 264 of the potential content creator devices based on the found matching hyper-specific criteria, the creator device identifier module 264 may also use the user requested client profile of the content creator device to further screen the initially selected potential content creator devices.

The hyper-specific media content module 270 may store the hyper-specific media contents that were previously transmitted by the content creator devices 220. The stored hyper-specific media contents may be associated with the hyper-specific criteria in the hyper-specific criteria module 268. In one example, the hyper-specific media content module 270 also stores the device identifiers of the content creator devices 220 that transmitted the stored hyper-specific media contents. In this regard, and upon finding the matching stored hyper-specific criteria in the hyper-specific criteria module 268, the creator device identifier module 264 may utilize the device identifiers to identify the potential content creator devices 220 as described above.

The time window module 272 may store user-requested time windows. The time window module 272 also stores the time windows for the previously transmitted hyper-specific media contents that may be associated with the hyper-specific criteria in the hyper-specific criteria module 270. The time window may include a range or the time period that overlaps with the rate of change of the specific subject or object that the consumer desires to view.

In some examples, the processor 206 may use a waiting period as a reference for collecting service fees. The waiting period may include a time duration within the time window where the consumer can back out or reject the transmissions of the hyper-specific media content without incurring financial obligations or paying only a reduced service fee. When a waiting period time duration elapses, the content crowdsourcing app 260 may initiate charging of service fees from the consumer device 210. In some cases, the waiting period is a user-configurable parameter where the consumer may enter in the consumer request the time duration for the waiting period. In other cases, the server may configure the waiting period based, for example, upon a policy or terms of engagement that is stored in a policy database. For example, the terms of engagement include a waiting period of ten minutes for a certain classification of hyper-specific media content (e.g., a three-hour concert). In another example, the preconfigured waiting period include one day for viewing of a spring break, and so on. In these examples, a detection of an initial delivery timestamp of the hyper-specific media content in the consumer device may trigger a timer for the time duration of the waiting period and the time window. Upon the lapse of the waiting period and within the time window, if the user has not rejected the transmissions or otherwise canceled the agreement, then the server may charge the consumer device with service fees. Before the lapse of the waiting period, the server may not charge service fees from the consumer device

The filter module 280 may be configured to screen or filter the content creator devices 220 that were selected based upon the hyper-specific criteria. The filter module 280 may also filter proposed bids from one or more responding content creator devices 220, apply a policy in the policy database 286 to accepted bid(s); and/or filter the livestream hyper-specific media content to be delivered to the consumer device 210. The filter module 280 may utilize the information in the client profile database 282, client geolocations database 284, and/or the policy database 286 to improve the services of transmitting hyper-specific media contents to the consumer device 110.

For example, the authoring qualifications in the consumer request includes a preferred user rating. In this example, the filter module 280 utilizes client profile information in the client profile database 282 to screen an initial number of content creator devices 220 that were selected based upon their respective association with the matching hyper-specific criteria in the hyper-specific criteria module 270. The client profile information may include user ratings, customer reviews, number of previous transactions that are related to the same specific object/subject at a specific location, pricing, quality of services, the ranking of each potential content creator device 220, and the like. In this regard, the filter module 280 may use an algorithm (not shown) to compare the user ratings between the initial number of content creator devices 220. Thereafter, the creator device identifier module 264 in communication with the filter module 280 may select the content creator devices 220 that include the preferred user ratings.

After the screening of the content creator devices 220 in the example above, the processor 206 in communication with the creator device identifier module 264 may retrieve their corresponding device identifications and utilize the retrieved device identifications for the sending of the consumer request. In response to the received consumer request, the receiving content creator devises 220 may send bid proposals by default, decline the consumer request, or respond with further queries.

Upon receiving the bids from the responding content creator devices 220, the filter module 280 may again utilize the extracted components of the hyper-specific criteria as references for filtering of the received bids. For example, the filter module 280 extracts the components of the received bids and compares these extracted components with the hyper-specific criteria in the consumer request. After this comparison, the filter module 280 may decline or cancel the received bids that do not relate to or satisfy the hyper-specific criteria in the consumer request. That is, the declined proposed bids are not presented to the consumer device 210.

The filter module 280 may also utilize the policy database 286 to implement terms of engagements or contractual obligations between the consumers, clients, subscribers, and/or other parties. For example, the filter module 280 applies the policy in the accepted bid(s) to make sure that pre-conditions and other requirements for the pending transaction between the consumer device 210 and the transmitting content creator device 220 are observed. In this example, the processor 206 and particularly, the media content monitoring module 208 in communication with the filter module 280 may be configured to implement, for example, the details of the applied policy such as, but not limited to, number of transmissions, retransmissions, uploading, etc. of the requested hyper-specific media content. As described herein, the policy database 286 may include information about terms of engagements between the consumer and content creator devices, cancellation policy, contractual obligation to pay service fees, refund policy, and the like.

Further functionalities of the content sharing services server 202 and its component features are described in greater detail, below.

Example Look-Up Table (LUT) for Authoring Qualification

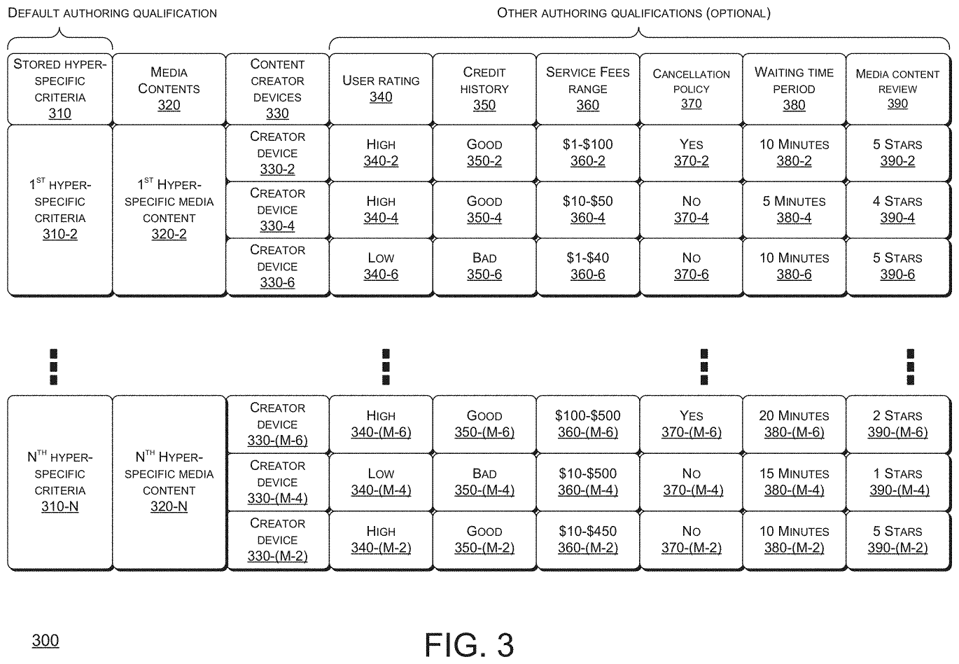

FIG. 3 is a block diagram of a LUT 300 that may be used to select the content creator devices that can capture the requested hyper-specific media content. In one example, the LUT 300 may include stored information that may be used for comparison with user-entered authoring qualifications to search for the content creator devices. In the following discussion of FIG. 3, continuing reference is made to the elements and reference numerals shown in and described with respect to the network server environment 200 and content sharing services server 202 of FIG. 2. For example, the creator device identifier module 264 utilizes the LUT 300 to search for the content creator devices that are most likely to give high quality of services to the requesting customer device.

LUT 300 includes a plurality of stored hyper-specific criteria 310(2)-310(N) that are considered as default authoring qualifications. The stored hyper-specific criteria 310(2)-310(N) are also associated hyper-specific media contents 320(2)-320(N), respectively. Each one of the stored hyper-specific criteria 310(2)-310(N) may be further associated with other authoring qualifications such as content creator devices 330, user ratings 340, credit history 350, service fees range 360, cancellation policy 370, waiting time period 380, and a media content review 390.

The stored hyper-specific criteria 310(2)-310(N) may include historical hyper-specific criteria that represent the hyper-specific media contents 320 that were previously transmitted by the content creator devices 330. The content creator devices 330 are similar to the content creator devices 220 in FIG. 2. In one example, multiple content creator devices 330 may be used to transmit the associated hyper-specific media content 320. In this regard, each one of the content creator devices 330 may also include different associated user ratings 340, credit history 350, and so on.

For example, for the 1^{st} stored hyper-specific criteria 310(2), the 1^{st} hyper-specific media content 320-2 may be transmitted by the content creator devices 330(2)-330(6). Given a situation where the authoring qualifications in the consumer request also include preferred user ratings, then the creator device identifier module 264 may select the content creator devices 330(2)-330(4) based on their corresponding user ratings 330. In another example, where the authoring qualifications in the consumer request include a combination of the hyper-specific criteria and the credit history, then the creator device identifier module 264 may select the content creator devices 330 based on the stored hyper-specific criteria 310 and the credit history 350, and so on.

As described herein, the user ratings 340 may include the evaluation of previous transactions made by the content creator devices 330. For example, the evaluation is made on the video quality of the captured hyper-specific media content 320. The credit history 350 may include the ability of the content creator devices to comply with their financial obligations/transactions. The service fees range 330 includes the range of payment to be made to the content creator devices 330 for capturing and transmitting the hyper-specific media content 320. The cancellation policy 370 may include a cancellation condition for transmission of the hyper-specific media content 320. The waiting time period 380 may include a time duration threshold before the services fees may be charged. The media content review 390 may include user-generated contents over the posted hyper-specific media content 320 in social networking platforms. The presented authoring qualifications are for illustration purposes only and other references may be used to further narrow the selection of the content creator devices.

Given a situation where no matching hyper-specific criteria 310 are found for the hyper-specific criteria in the consumer request, the creator device identifier module 264 may create a new entry of hyper-specific criteria and store the newly created hyper-specific criteria in the LUT 300. The creator device identifier module 264 may then populate the content creator devices 330, user ratings 340, etc. in the process. In one example, the time condition component of the hyper-specific criteria 310 may include future events and corresponding time windows (not shown).

Example Implementation—Selecting Content Creator Devices

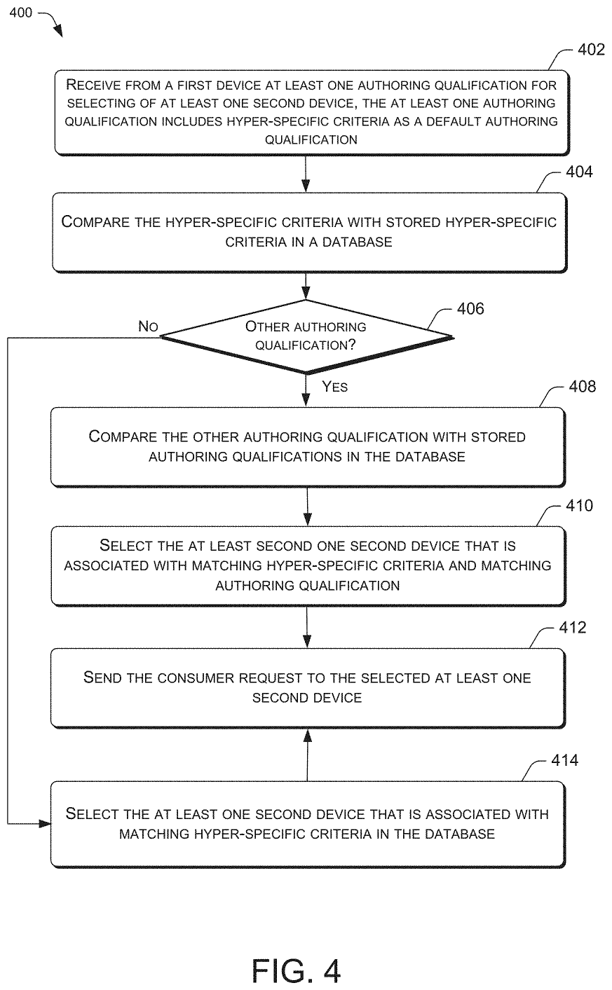

FIG. 4 is a flow diagram 400 that depicts a methodological implementation of at least one aspect of the techniques for selecting one or more content creator devices based upon at least one authoring qualification in the consumer request. In one example, the at least one authoring qualification may include the hyper-specific criteria in the consumer request as the default authoring qualification. In the following discussion of FIG. 4, continuing reference is made to the elements and reference numerals shown in and described with respect to the network server environment 200 and content sharing services server 202 of FIG. 2. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 402, the communication interface 204 in the content sharing services server 202 receives from the first device the at least one authoring qualification including the hyper-specific criteria for selecting the at least one second device that will capture a requested hyper-specific media content. The first device, for example, includes the consumer device 210 that sends the consumer request including the at least one authoring qualification to the content sharing services server 202. In one example, the at least one authoring qualification may include the hyper-specific criteria as the default authoring qualification. In some cases, other authoring qualifications such as preferred user ratings, preferred credit history, service fees range, cancellation policy, etc. may be combined with the default hyper-specific criteria.

At block 404, the creator device identifier module 264 compares the hyper-specific criteria with stored hyper-specific criteria in the hyper-specific criteria module 270. The stored hyper-specific criteria may be associated with previously transmitted hyper-specific media contents. Further, the stored hyper-specific criteria are associated with content creator devices that previously transmitted these hyper-specific media contents.

At decision block 406, the creator device identifier module 264 determines whether other authoring qualification is present in the consumer request. As described above, the hyper-specific criteria may be used as the default authoring qualification and other authoring qualifications may be optionally added in the consumer request to further narrow the search for content creator devices. Given a situation where at least one other reference is present (“Yes” at block 406), then at block 408, the creator device identifier module 264 compares the additional reference with the authoring qualifications in the database. In one example, a LUT (e.g., LUT 300 in FIG. 3) may include the other authoring qualifications that can be used for comparisons with the authoring qualifications in the consumer request.

At block 410, the creator device identifier module 264 selects at least one second device that is associated with matching hyper-specific criteria and matching authoring qualification. At block 412, the processor 206 in communication with the creator device identifier module 264 may send the consumer request to the selected at least one second device.

Referring back to decision block 406, when no additional authoring qualification is present (“No” at block 406), then at block 414, the creator device identifier module 264 selects at least one second device that is associated with matching hyper-specific criteria in the database. Thereafter, the process goes back to block 412 where the processor 206 in communication with the creator device identifier module 264 may send the consumer request to the selected at least one second device.

### Example Implementation—Selecting Content Creator Devices Based on Device Location

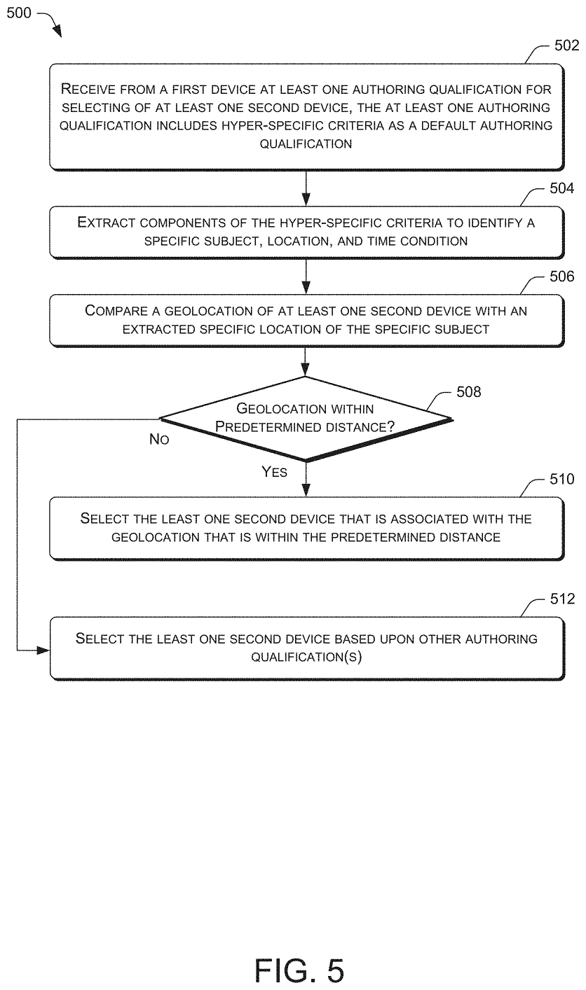

FIG. 5 is a flow diagram 500 that depicts a methodological implementation that depicts another methodological implementation of at least one aspect of the techniques for selecting the one or more content creator devices based upon their distance proximity from the specific location of the specific subject. In the following discussion of FIG. 5, continuing reference is made to the elements and reference numerals shown in and described with respect to the network server environment 200 and content sharing services server 202 of FIG. 2. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 502, the communication interface 204 in the content sharing services server 202 receives from the first device the at least one authoring qualification including the hyper-specific criteria for selecting the at least one second device that will capture a requested hyper-specific media content. The first device, for example, includes the consumer device 210 that sends the consumer request including the at least one authoring qualification to the content sharing services server 202.

At block 504, the consumer request module 262 receives and extracts components the hyper-specific criteria to identify a specific subject, location, and time condition components.

At block 506, the creator device identifier module 264 compares the geolocation of at least one second device with the extracted specific location of the specific subject. For example, the creator device identifier module 264 retrieves the geolocation of all content creator devices 220 from the client geolocations database 284. In this example, the creator device identifier module 264 compares the retrieved geolocations with the extracted specific location of the specific subject.

If the retrieved geolocation is within a predetermined distance from the specific location of the specific subject (“Yes” at decision block 508), then, at block 510, the creator device identifier module 264 selects the content creator devices that are associated with the geolocations that are within the predetermined distance. For example, the specific subject and location include “Bill's Bar” and “6^{th} Street, Austin, Tex.,” respectively. In this example, the content creator devices that are within the predetermined distance from 6^{th} Street, Austin, Tex. are selected to transmit the media content. The predetermined distance may include user-configurable parameters such as within 100 meters from the specific location.

If the retrieved geolocation is outside of the predetermined distance from the specific location of the specific subject (“No” at decision block 508), then, at block 512, the creator device identifier module 264 selects the content creator devices based on other authoring qualifications to narrow the selection of content creator devices. For example, the other authoring qualification includes a combination of the hyper-specific criteria and the preferred client profile. In this case, the creator device identifier module 264 utilizes the stored hyper-specific criteria and the client profile information in the database to select the associated content creator devices.

### Example Implementation—Payment of Service Fees

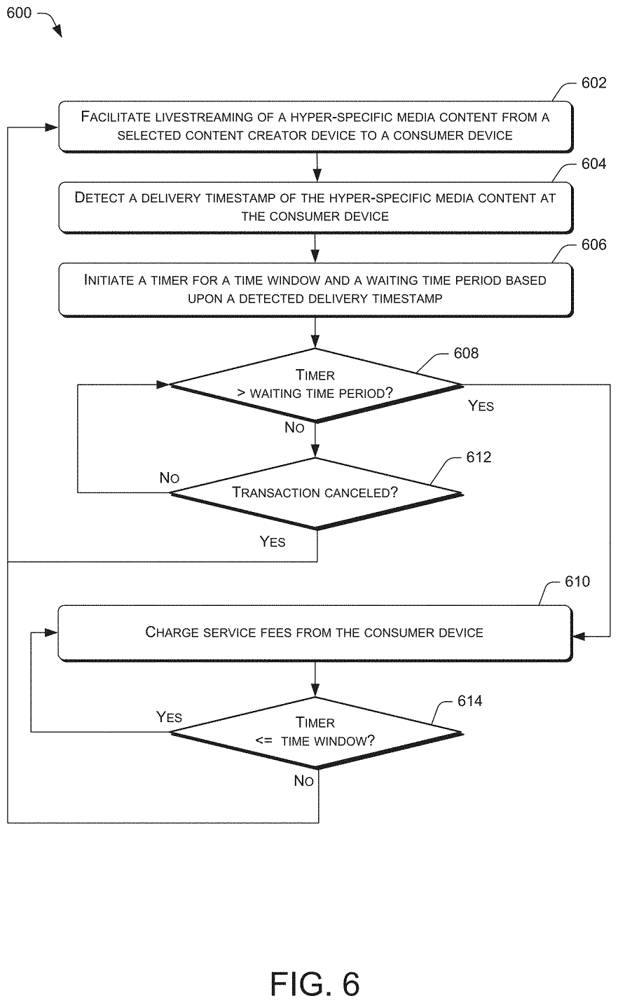

FIG. 6 is a flow diagram 600 that depicts a methodological implementation of at least one aspect of the techniques for initiating the charging of service fees from the viewing consumer device. Particularly, the consumer is contractually obliged to pay at the lapse of the waiting time period. In the following discussion of FIG. 6, continuing reference is made to the elements and reference numerals shown in and described with respect to the network server environment 200 and content sharing services server 202 of FIG. 2. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 602, the processor 206 in communication with the communication interface 204 facilitates the livestreaming of the hyper-specific media content between the transmitting content creator device and the consumer device. In some examples, the content sharing services server 202 and particularly, the processor 206 may facilitate the transmission of the hyper-specific media content from the transmitting content consumer device 220 to the consumer device 210.

At block 604, the processor 206 and particularly, the media content monitoring module 208 detects a delivery timestamp of the hyper-specific media content at the receiving consumer device 210. The media content monitoring module 208 may monitor the transmissions of the hyper-specific media content, detect delivery timestamps at the consumer device, detect deviations in the terms of engagement by the contracting parties such as a change in the data rates during transmission, limit in the number of transmissions, changes in the specific subject that are currently transmitted, and the like. At block 604, the media content monitoring module 208 detects the initial delivery timestamp of the hyper-specific media content. The initial delivery timestamp may be utilized to, for example, to initiate a timer for the waiting time period (e.g., waiting time period 380 in LUT 300) and the time window in the consumer request.

At block 606, the processor 206 initiates a timer for the waiting time period and the time window upon the detection of the delivery timestamp. The waiting time period may include a time duration that starts to run from the detection of the initial delivery timestamp of the hyper-specific media content. In some examples, the waiting time period and the time window may use the same timer.

At decision block 608, the processor 206 determines whether the timer is greater than the time duration of the waiting period. If the delivery timestamp is greater than the waiting period time duration (“Yes” at block 608), then, at block 610, the processor 206 may initiate charging of service fees from the consumer device. If the waiting period time duration has yet to elapse (“No” at block 608), then, at decision block 612, the processor 206 verifies whether the transaction to engage the services of the transmitting content creator device 220 has been canceled by the consumer device 210. If the transaction to engage the services of the transmitting content creator device 220 has been canceled by the consumer device 210 (“Yes” at decision block 612), then, the process goes back to block 602 where the processor 206 is facilitating the livestreaming of the hyper-specific media content. Otherwise, if the transaction has yet to be canceled (“No” at decision block 612), then the process goes back to decision block 608 to determine whether the delivery timestamp has reached the waiting period time duration.

At decision block 614, the processor 206 determines whether the time window has elapsed since the initiation of the service fee charges. If the timer is less than or equal to the specified duration of the time window (“Yes” at block 614), then, the process goes back to block 610 where the processor 206 charges service fees from the consumer device. If the timer greater than the specified duration of the time window (“No” at block 614), then, the process goes back to block 602 where the processor 206 facilitates the livestreaming of the hyper-specific media contents.

In the implementations described herein, the authoring qualifications may facilitate capturing of specifically requested subject at a particular location and time condition by content creator devices that are likely to provide high-quality services. For example, the services are above a certain threshold as requested in the authoring qualifications.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

1. One or more computer-readable storage media storing computer-executable instructions that upon execution cause one or more processors to perform acts comprising:
receiving, from a first device, a consumer request for a real-time delivery of a hyper-specific media content that includes a specific subject, location, and time window that is based upon and overlaps with an expected rate of change of details of the specific subject of the hyper-specific media content for a particular future event;
using the hyper-specific media content as an authoring qualification to select at least one second device that will provide the real-time delivery of the hyper-specific media content; and
using a selected at least one second device to transmit in real-time the hyper-specific media content over at least the time window that overlaps with the expected rate of change of details of the specific subject of the hyper-specific media content for the particular future event.

2. The one or more computer-readable storage media of claim 1, wherein the hyper-specific media content is used as a default authoring qualification to select the at least one second device.

3. The one or more computer-readable storage media of claim 2, wherein a user rating is combined with the default authoring qualification to select the at least one second device.

4. The one or more computer-readable storage media of claim 1, wherein the hyper-specific media content is used to filter proposed bids from a plurality of potential second devices.

5. The one or more computer-readable storage media of claim 1 further comprising: using a distance between a geolocation of the at least one second device and the specific location of the specific subject as an additional authoring qualification to select the at least one second device.

6. The one or more computer-readable storage media of claim 1, wherein the expected rate of change of details of the specific subject includes a length of time between an expected time of occurrence and ending of the hyper-specific media content.

7. The one or more computer-readable storage media of claim 1, wherein the at least one second device is selected from potential second devices that are associated with previously transmitted hyper-specific media contents.

8. The one or more computer-readable storage media of claim 1, wherein the first device is charged with service fees upon a lapse of a waiting time period from an initial transmission of the hyper-specific media content by the selected at least one second device.

9. The one or more computer-readable storage media of claim 8, wherein a timer for the waiting time period is initiated upon a detection of a delivery timestamp of the hyper-specific media content at the first device.

10. A device, comprising:
a processor;
a memory coupled to the processor and having instructions stored therein, the instructions, when executed by the processor, cause the processor to perform acts comprising:
receiving a consumer request for a real-time delivery of a hyper-specific media content that includes a specific subject, location and time window that is based upon and overlaps with an expected rate of change of details of Hall the specific subject of the hyper-specific media content for a particular future event; and
using the hyper-specific media content for selecting at least one content creator device that will provide the real-time delivery of the hyper-specific media content, wherein a selected at least one content creator device is configured to transmit in real-time the hyper-specific media content over at least the time window that overlaps with the expected rate of change of details of the specific subject of the hyper-specific media content for the particular future event.

11. The device of claim 10, wherein the hyper-specific media content is used as a default authoring qualification select the at least one content creator device.

12. The device of claim 11, wherein the processor combines a user rating with the default authoring qualification to select the at least one content creator device.

13. The device of claim 10, wherein the hyper-specific media content is used to filter proposed bids from a plurality of content creator devices.

14. The device of claim 10, wherein the processor uses from a distance between a geolocation of the at least one content creator device and the specific location of the specific subject as an additional authoring qualification to select the at least one content creator device.

15. The device of claim 10, wherein the time condition includes a length of time between an expected time of occurrence and ending of the hyper-specific media content.

16. The device of claim 10, wherein the at least one content creator device is selected from potential content creator devices that are associated with previously transmitted hyper-specific media contents.

17. The device of claim 10, wherein the processor utilizes a lapse of a waiting time period from an initial transmission of the hyper-specific media content to charge service fees.

18. A computer-implemented method, comprising:
receiving, from a first device, a consumer request for a real-time transmission of a hyper-specific media content that includes an information about a specific subject, location, and flail time window that overlaps with an expected rate of change of details of the specific subject of the hyper-specific media content for a particular future event;
comparing the hyper-specific media content with stored hyper-specific media contents in a database that are associated with corresponding second devices; and
selecting at least one second device from the second devices that is associated with a matching hyper-specific media content in the database, wherein a selected at least one second device is configured to transmit in real-time the hyper-specific media content over at least the window that overlaps with the expected rate of change of details of the specific subject of the hyper-specific media content for the particular future event.

19. The computer-implemented method of claim 18, wherein the hyper-specific media content is combined with a user rating to select the at least one second device.

20. The computer-implemented method of claim 18, wherein the first device is charged with service fees upon a lapse of a waiting time period from an initial transmission of the hyper-specific media content by the selected at least one second device.
